(19) United States
(12) Patent Application Publication
(10) Pub. No.: US 2015/0025892 A1
(43) Pub. Date: Jan. 22, 2015

(54) METHOD AND SYSTEM FOR TEMPLATE-BASED PERSONALIZED SINGING SYNTHESIS

(71) Applicant: Agency for Science, Technology and Research, Singapore (SG)

(72) Inventors: Siu Wa Lee, Singapore (SG); Ling Cen, Singapore (SG); Haizhou Li, Singapore (SG); Yaozhu Paul Chan, Singapore (SG); Minghui Dong, Singapore (SG)

(73) Assignee: Agency for Science, Technology and Research, Singapore (SG)

(21) Appl. No.: 14/383,341

(22) PCT Filed: Mar. 6, 2013
(86) PCT No.: PCT/SG2013/000094

§ 371 Date: Sep. 5, 2014

(30) Foreign Application Priority Data
Mar. 6, 2012 (SG) 2012101581-4

(51) Int. Cl. G10L 13/02; G10L 21/007

(52) U.S. Cl. CPC G10L 13/02; G10L 21/007
USPC 704/267; 704/258; 704/268

(57) ABSTRACT

A system and method for speech-to-singing synthesis is provided. The method includes deriving characteristics of a singing voice for a first individual and modifying vocal characteristics of a voice for a second individual in response to the characteristics of the singing voice of the first individual to generate a synthesized singing voice for the second individual. In one embodiment the method includes deriving a template of first speech characteristics and first singing characteristics in response to a first individual's speaking voice and singing voice and extracting second speech characteristics from a second individual's speaking voice, then modifying the second speech characteristics in accordance with the template to generate the second individual's approximated singing voice and aligning acoustic features of the second individual's approximated singing voice in response to the first speech characteristics, the first singing characteristics and the second speech characteristics to generate the second individual's synthesized singing voice.

### PRIORITY CLAIM

The present application claims priority to Singapore Patent Application No. 201201581-4, filed 6 Mar. 2012.

### FIELD OF THE INVENTION

The present invention generally relates to voice synthesis, and more particularly relates to a system and method for template-based personalized singing synthesis.

### BACKGROUND OF THE DISCLOSURE

There has been a constant increase in the direct impact of computer-based music technology on the entertainment industry from the use of Linear Predictive Coding (LPC) to synthesize singing voices in a computer in the 1960's to present day synthesis technology. For example, singing voice synthesis technology, such as synthesis of singing voices from a spoken voice of the lyrics, has many applications in the entertainment industry. The advantage of singing synthesis by speech to singing conversion is that the timbre of the voice is easy to keep. Thus higher singing voice quality is easy to achieve and personalized singing voice can be generated. However, one of the biggest difficulties is that it is not easy to generate natural melody from musical score when synthesizing singing voice.

Based on the source used in the generation of singing, singing voice synthesis can be classified into two categories. In the first category, singing voices are synthesized from the lyrics of a song, which is called lyrics-to-singing synthesis (LTS). Singing voices in the second category are generated from spoken utterances of the lyrics of the song. This is called speech-to-singing (STS) synthesis.

In LTS synthesis, corpus-based methods, such as wave concatenation synthesis and Hidden Markov Model (HMM) synthesis, are mostly used. This is more practical than traditional systems using methods such as vocal tract physical modeling and formant-based synthesis.

Compared to LTS synthesis, STS synthesis has received far less attention. However, STS synthesis can enable a user to produce and listen to his/her singing voice merely by reading the lyrics of songs. For example, STS synthesis can modify the singing of an unprofessional singer by correcting the imperfect parts to improve the quality of his/her voice. As the synthesized singing preserves the timbre of the speaker, the synthesized singing will sound like it is being sung by the speaker, making it possible to create a professional-quality singing voice for poor singers.

However, present STS systems are complex and/or difficult to implement by the end-user. In one conventional method, the singing voice is generated by manually modifying the F0 contour, phoneme duration, and spectrum of a speaking voice. Another STS system has been proposed where the F0, phoneme duration, and spectrum are automatically controlled and modified based on not only the information from the music score of the song, but, also its tempo. A system for synthesizing singing voices in Chinese has also been proposed, yet it requires inputting not only the Chinese speech and the lyrics of the song, but also inputting the music score. The fundamental frequency contour of a synthesized singing voice is generated from the pitch of the score and the duration is controlled using a piecewise-linear function, in order to generate the singing voices.

Thus, what is needed is a system and method for speech-to-singing synthesis which reduces complexity of the synthesis as well as simplifying operations by the end user. Furthermore, other desirable features and characteristics will become apparent from the subsequent detailed description and the appended claims, taken in conjunction with the accompanying drawings and this background of the disclosure.

### SUMMARY

According to the Detailed Description, a method for speech-to-singing synthesis is provided. The method includes deriving characteristics of a singing voice for a first individual and modifying vocal characteristics of a voice for a second individual in response to the characteristics of the singing voice of the first individual to generate a synthesized singing voice for the second individual.

In accordance with another aspect, a method for speech-to-singing synthesis is provided. The method includes deriving a template of first speech characteristics and first singing characteristics in response to a first individual's speaking voice and singing voice and extracting second speech characteristics from a second individual's speaking voice. The method also includes modifying the second speech characteristics in accordance with the template to generate the second individual's approximated singing voice and aligning acoustic features of the second individual's approximated singing voice in response to the first speech characteristics, the first singing characteristics and the second speech characteristics to generate the second individual's synthesized singing voice.

In accordance with yet another aspect, a method for speech-to-singing synthesis is provided. The method includes extracting pitch contour information and alignment information from a singing voice of a first individual and extracting alignment information and a spectral parameter sequence from a spoken voice of a second individual. The method further includes generating alignment information from the alignment signals of the singing voice of the first individual and the alignment signals of the spoken voice of the second individual and converting the spectral parameter sequence from the spoken voice of the second individual in response to the alignment information to generate a converted spectral parameter sequence. Finally, the method includes synthesizing a singing voice for the second individual in response to the converted spectral parameter sequence and the pitch contour information of the singing voice of the first individual.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment.

FIG. 1 depicts a flowchart illustrating an overview of a method for a template-based speech-to-singing synthesis system in accordance with an embodiment.

FIG. 2 depicts a block diagram of a template-based speech-to-singing synthesis system for enabling the method of FIG. 1 in accordance with the present embodiment.

FIG. 3 depicts a block diagram of a first variant of the alignment process of the template-based speech-to-singing synthesis system of FIG. 2 in accordance with the present embodiment.

FIG. 4 depicts a block diagram of a second variant of the alignment process of the template-based speech-to-singing synthesis system of FIG. 2 in accordance with the present embodiment.

FIG. 5 depicts a block diagram of a third variant of the alignment process of the template-based speech-to-singing synthesis system of FIG. 2 in accordance with the present embodiment.

FIG. 6 depicts a more complete block diagram of the template-based speech-to-singing synthesis system of FIG. 2 in accordance with the present embodiment.

FIG. 7 depicts a process block diagram of the template-based speech-to-singing synthesis system of FIG. 2 in accordance with the present embodiment.

FIG. 8, comprising FIGS. 8A and 8B, depicts voice patterns and the combination of the voice patterns in a time warping matrix, wherein FIG. 8A is a combines the template speaking voice and the template singing voice to derive the time warping matrix and FIG. 8B combines the new speaking voice and the template speaking voice to derive the time warping matrix.

And FIG. 9 illustrates modified duration of a set of predetermined phonemes, wherein the top depiction shows a spectrogram of a template singing voice, the middle depiction shows a spectrogram of converted speech, and the bottom depiction shows a spectrogram of converted singing voice.

Skilled artisans will appreciate that elements in the figures are illustrated for simplicity and clarity and have not necessarily been depicted to scale. For example, the dimensions of some of the elements in the block diagrams or flowcharts may be exaggerated in respect to other elements to help to improve understanding of the present embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of this invention to present a template based speech-to-singing (STS) conversion system, in which a template singing voice from an individual, such as a professional singer, is used in the system to synthesize a singing voice from another individual's speaking voice.

Unlike previous techniques that estimate the acoustic features for synthesized singing voices based on the music score of a song, operation in accordance with the present embodiment generates a singing voice merely from a speaking voice reading the lyrics. A user's spoken voice is converted into singing using the timbre of the speaker's voice while applying the melody of a professional voice. In this manner, a singing voice is generated from speech reading the lyrics of a song. The acoustic features are modified based on the differences between singing and speaking voices determined by analyzing and templating singing and speaking voices from the same person. Thus, a music score of a song is advantageously not required as an input reducing the complexity of the operation of the system and, consequently, making it easier for end-users. In addition, a natural pitch contour is acquired from an actual singing voice without needing to modify a step contour to account for F₀ fluctuations such as overshoot and vibrato. This can potentially improve the naturalness and quality of the synthesized singing. Also, by aligning singing and speaking voices automatically, there is no need to perform manual segmentation for the speech, thereby enabling a truly automatic STS system.

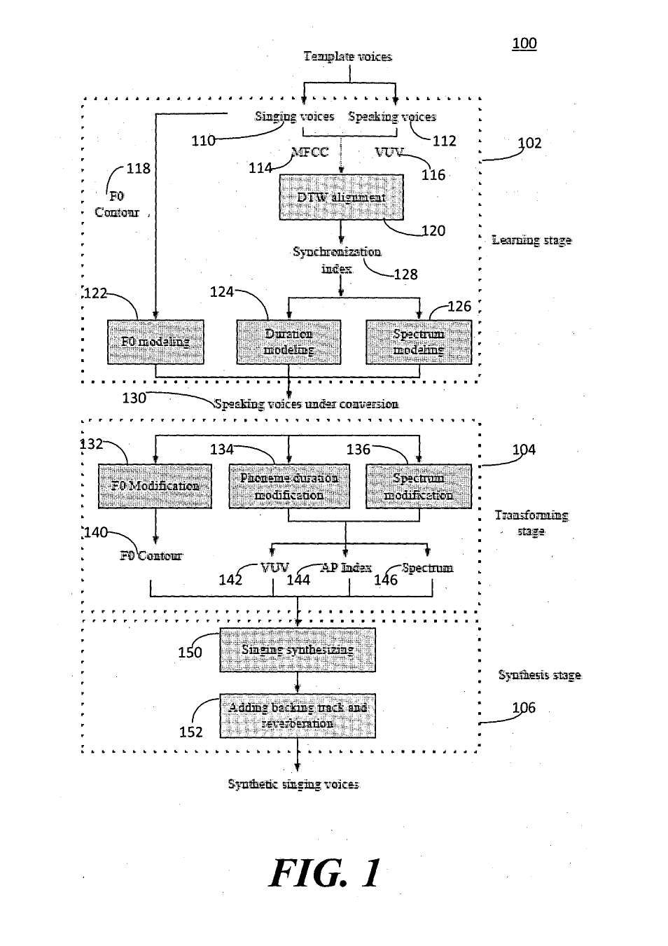

Thus, in accordance with the present embodiment, a template-based STS system converts speaking voices into singing voices by automatically modifying the acoustic features of the speech with the help of pre-recorded template voices. Referring to FIG. 1, the entire system 100 can be broken down into three stages: a learning stage 102, transformation stage 104 and a synthesis stage 106.

In the learning stage 102, the template singing voice 110 and the template speaking voice 112 are analyzed to extract the Mel-Frequency Cepstral Coefficients (MFCC) 114, short-time energy (not shown), voice and unvoiced (VUV) information 116, fundamental frequency (F₀) contour 118, and spectrum (not shown). The MFCC 114, energy and VUV 116 are used as acoustic features in the alignment 120 of the singing and speech in order to accommodate their differences in timing and achieve optimal mapping between them. In accordance with the present embodiment, dynamic time warping (DTW) is used for the alignment 120. The transformation models for the F₀ contour 118 (i.e., the F₀ modeling 122) and phoneme duration (including the duration modeling 124 and the spectrum modeling 126) are then derived based on the synchronization information (i.e., the synchronization index 128) obtained.

In the transformation stage 104, features are extracted for the new speaking voice 130 which is usually uttered by a different person from the template speaker. These features are the MFCC, the short-time energy, the VUV information, the F₀ contour, and the spectrum. These are modified (i.e., F₀ modification 132, a phoneme duration modification 134 and a spectrum modification 136) to approximate those of the singing voice based on the transformation models, generating a F₀ contour 140, VUV information 142, an aperiodicity (AP) index 144, and spectrum information 146.

After these features have been modified, the singing voice is synthesized 150 in the last stage 106. For enhancing the musical effect, the backing track and reverberation effect may be added 152 to the synthesized singing. In our implementation, the analysis of speech and singing voices as well as singing voice synthesis are carried out using STRAIGHT, a high quality speech analysis, modification synthesis system that is an extension of the classical channel VOCODER.

It is certain for the point of entry and duration of each phoneme in a singing voice to be different from those in a speaking voice. The two voices 110, 112 are aligned 120 before deriving the transformation models 122, 124, 126 and carrying out acoustic feature conversion 104. The quality of the synthesized singing voice is largely dependent on the accuracy of these alignment results. In accordance with the present embodiment, a two-step DTW-based alignment method using multiple acoustic features is employed at the alignment 120.

Prior to alignment 120, the silence is removed from the signals to be aligned. This silence is detected based on energy and spectral centroid and removal of the silence in accordance with the present embodiment improves the accuracy of alignment. MFCC 114, short-time energy (not shown) and voiced/unvoiced regions 116 are then extracted as acoustic features for deriving aligned data. MFCC 114 are popular features used in Automatic Speech Recognition (ASR) and MFCC 114 computes the cosine transform of the real logarithm of the short-time power spectrum on a Mel-warped frequency scale. Since the same lyrics having equal syllables are uttered in both singing 110 and speech 112, the voiced and unvoiced regions 116 can provide useful information for alignment 120 and, hence, is extracted as a feature prior to alignment 120.

Besides the raw features 114, 116, the Delta and Acceleration (Delta-Delta) of these features 114, 116 are also calculated. Frame- and parameter-level normalization are carried out on the features 114, 116 to reduce the acoustic variation across different frames and different parameters. The normalization is performed by subtracting the mean and dividing by the standard deviation of the features 114, 116.

During the alignment 120, the acoustic features of different signals are aligned with each other using the DTW. The DTW algorithm measures the similarity between two sequences which vary in time or speed, aiming to find an optimal match between them. The similarity between the acoustic features of two signals is measured using cosine distance as follows:

$$s = \frac{{x}_{i} \cdot {y}_{j}}{‖ {x}_{i} ‖ ‖ {y}_{j} ‖} , \qquad ( 1 )$$

where s is the similarity matrix, and xi and yj are the feature vectors of i-th and j-th frames in two signals, respectively.

To improve the accuracy in aligning the new speaking utterance to be converted with the template singing voice that is sung by a different speaker, a two-step alignment is implemented. The alignment 120 is the first step and aligns the template singing voice 110 and the template speaking voice 112 from the same speaker. Alignment data from the alignment 120 is then used to derive the mapping models 124, 126 of the acoustic features between singing and speech

A second alignment step (not shown in FIG. 1) is performed to align template speech 112 and the new speaking voice 130. The synchronization information derived from this alignment data together with that acquired from aligning 120 the template voices is used to find the optimal mapping between the template singing 110 and the new speech 130.

After the mapping between singing and speaking voices is achieved via the alignment 120, the transformation models 124, 126 are derived based on the template voices. The acoustic features of the new speech 130 are then modified 132, 134, 136 to obtain the features for the synthesized singing. Prior to transformation 104, interpolation and smoothing are carried out on the acoustic features to be converted if their lengths are different from those of the short-time features used in alignment. In view of accuracy and computational load, template voices are divided into several segments and the transformation models are trained separately for each segment. When a new instance of speech is converted into singing using the trained transformation models, it needs to be segmented similarly to the template speech. In the proposed system, the F₀ contour of the speaking voice is modified 132 by acquiring a natural F₀ contour 140 from template singing voice. In doing so, we do not need to modify a step contour to account for F₀ fluctuations such as overshoot and vibrato. The synthesized singing voice could be more natural with the F₀ contour of the actual singing. The phoneme durations of the speaking voice are different from that in the singing voice and should be lengthened or shortened during the transformation 104 in accordance with the singing voice at the phoneme duration modification 134.

Unlike conventional STS systems, the musical score is not required as an input to derive the duration of each phoneme in singing, and we also do not need to carry manual segmentation for each phoneme of the speaking voice before conversion. Instead, the synchronization information from aligning the template voices and the converted speech is used to determine the modification for phoneme duration 134. The duration of each phoneme in the speech is modified to be equal to that in the template singing. To implement this, the VUV, spectral envelope and aperiodicity (AP) index estimated using a vocoder such as STRAIGHT are compressed or elongated in accordance with the transformation model of phoneme duration.

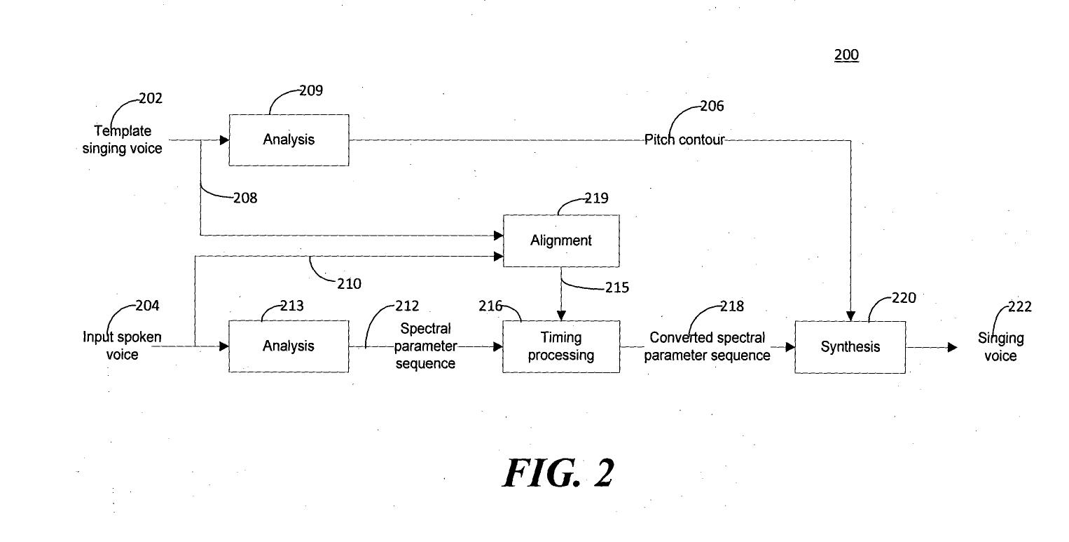

Referring to FIG. 2, a simplified diagram 200 of a template-based personalized singing synthesis system in accordance with the present embodiment is depicted. Initially, a template of speech characteristics and singing characteristics of a singing voice 202 is derived in response to a first individual's speaking and singing voice. Pitch contour information 206 and alignment information 208 are extracted from the template singing voice 202, the pitch contour information 206 being extracted by analysis 209. Also, alignment information 210 and spectral parameter sequence information 212 are extracted from a second individual's spoken voice 204, the spectral parameter sequence information 212 being extracted by analysis 213. Alignment 214 of the alignment information 210 of the second individual's spoken voice 204 and the alignment information 208 of the template singing voice 202 is performed to set up the time mapping between the segments of same sound in the two different sequences. The alignment 214 generates alignment information 215 which is used to change the timing of the input spoken voice signal during timing processing 216 so that each small pieces of the generated signal (i.e., converted spectral parameter sequence 218 resulting from converting the spectral parameter sequence 212 in response to the alignment information at the timing processing 216) will have the same timing as those in the template singing voice 202.

The major aim of the analysis 209 of the singing voice 202 is to extract the pitch contour 206 of the singing voice 202 so as to extract the melody of the song from the professional voice. The aim of the analysis 213 of the spoken voice 204 is to extract the spectral parameter sequence 212 from the spoken voice 204 to capture the timbre of the spoken voice 204 for synthesis 220.

In accordance with the present invention, the timing processing 216 obtains the alignment information 215 from the alignment 214 and uses the alignment information 215 to convert the spectral sequence 212 to regenerate the converted spectral parameter sequence 218 of the target singing voice. Compared to the spoken voice 204, some voice segments are stretched to be longer, and some segments are compressed to be shorter. Each piece of the voice segments in the converted spectral parameter sequence 218 will match its corresponding part in the template singing voice 202. The synthesizer 220 then uses the converted spectral parameter sequence 218 and the pitch contour 206 from the template singing voice 202 to synthesize a personalized singing voice 222.

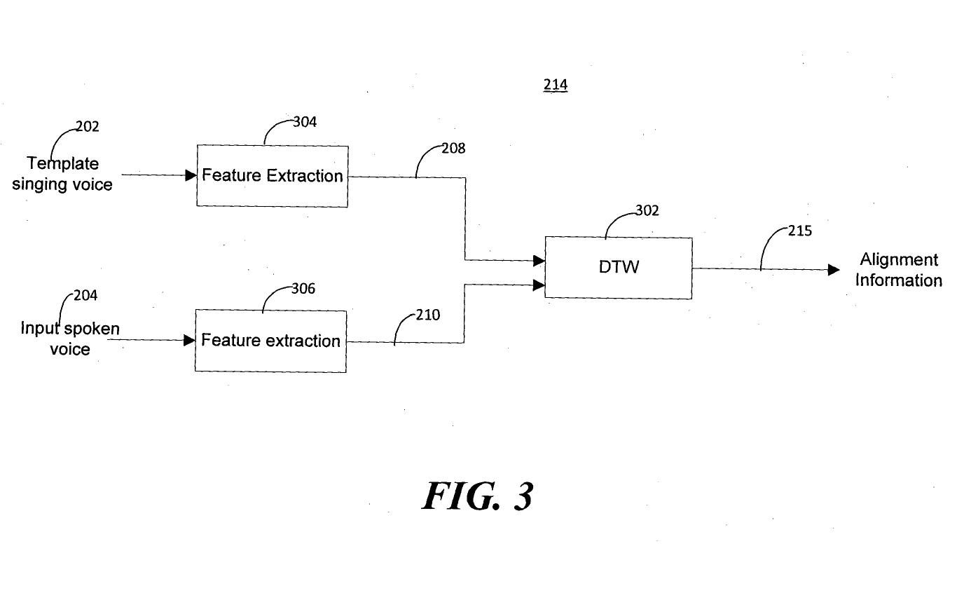

The alignment process 214 can be implemented in accordance with the present embodiment in one of three variants depicted in FIGS. 3, 4 and 5. Referring to FIG. 3, a first variant of the alignment process 214 aligns the alignment information 208, 210 directly in accordance with a dynamic time warping (DTW) method 302. Feature extraction 304 extracts the alignment information 208 from the template singing voice 202. Similarly, feature extraction 306 extracts the alignment information 210 from the input spoken voice 204. The DTW 302 generates the alignment information 215 by dynamic time warping 302 the alignment information 208, 210.

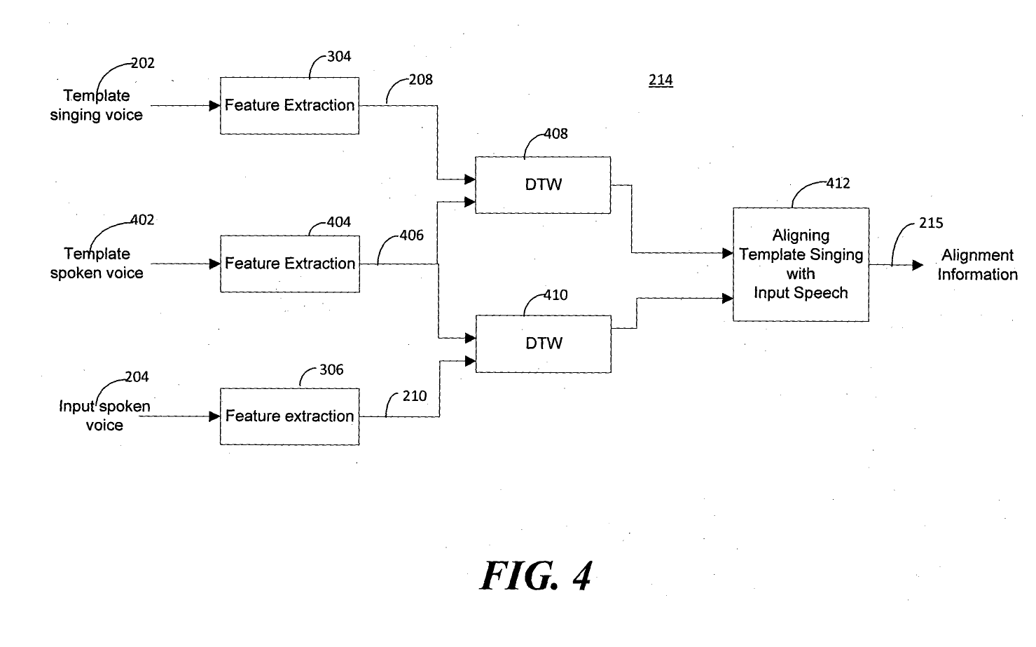

Referring to FIG. 4, a second variant of the alignment method 214 uses a template spoken voice 402 as a reference for alignment. When comparing the template singing voice 202 with the input spoken voice 204, two main factors determine the differences of the signals. One is the speaker identity (two different speakers), another is the style of the signals (spoken and singing). To reduce the difficulty of the matching and improve the accuracy of the alignment 214, we can introduce a template spoken voice 402, which is produced by the singer (i.e., the same individual that produces the template singing voice 202).

Feature extraction 304 extracts the alignment information 208 from the template singing voice 202. Similar to feature extraction 304 and feature extraction 306, feature extraction 404 extracts alignment information 406 from the template spoken voice 402. Then a two-step DTW is performed. First, the template singing voice 202 is matched with the template spoken voice 402 by DTW 408 of the alignment information 208 and the alignment information 406. Because the two voices 202, 402 are from the same speaker, the spectra of the two signals are similar with the major differences being in the timing and pitch. Thus, it is easier to align the two signals 208, 406 than to align the two signals 208, 210 (FIG. 3). Next, the alignment information 406, 210 of the template spoken voice 402 and the input spoken voice 204 are combined by DTW 410. Since both of the signals 406, 210 are spoken signals, the only difference is timbre difference due to speaker difference, thereby also facilitating alignment of the two signals 406, 210 by the DTW 410. At alignment 412, the two pieces of alignment information from the DTWs 408, 410 are combined, thereby generating the alignment information 215 between the input spoken voice 204 and the template singing voice 202.

In accordance with the present embodiment and this second variant of the alignment 214, the template singing and speaking voices 202, 402 are analyzed to extract the Mel-Frequency Cepstral Coefficients (MFCC), short-time energy, voice and unvoiced (VUV) information, F₀ contour and spectrum, which in layman terms are the pitch, timing and spectrum. The transformation model for F₀ 122 (FIG. 1) is then derived based on the information obtained. For personalized speaking-to-singing synthesis, features are extracted for the individual's speaking voice 204 and these features are modified to approximate those of the singing voice based on the transformation models 122, 124, 126 (FIG. 1) derived.

The dynamic time warping (DTW) algorithm is used to align the acoustic features extracted for the template singing and speaking voices 202, 402 and for the individual's speaking voice 204. A two-step alignment is done to align the speaking and singing voices. First, the template singing and speaking voices 202, 402 from the same person are aligned 408 and the alignment data is used to derive mapping models 124, 126 (FIG. 1) of the acoustic features between singing and speech. Then, the template speech 402 and the new speaking voice 204 is aligned 410 and the synchronization information derived from this alignment data together with that acquired from aligning the template voices is used to find the optimal mapping 215 (FIG. 2) between the template singing and the new speech. In this manner, synthesis 220 (FIG. 2) of the new individual's singing voice can be obtained from the extracted pitch, timing and spectrum of the individual's speaking voice whereby the spectrum of the speaking voice is retained but the pitch and timing is replaced with those from the singing voice.

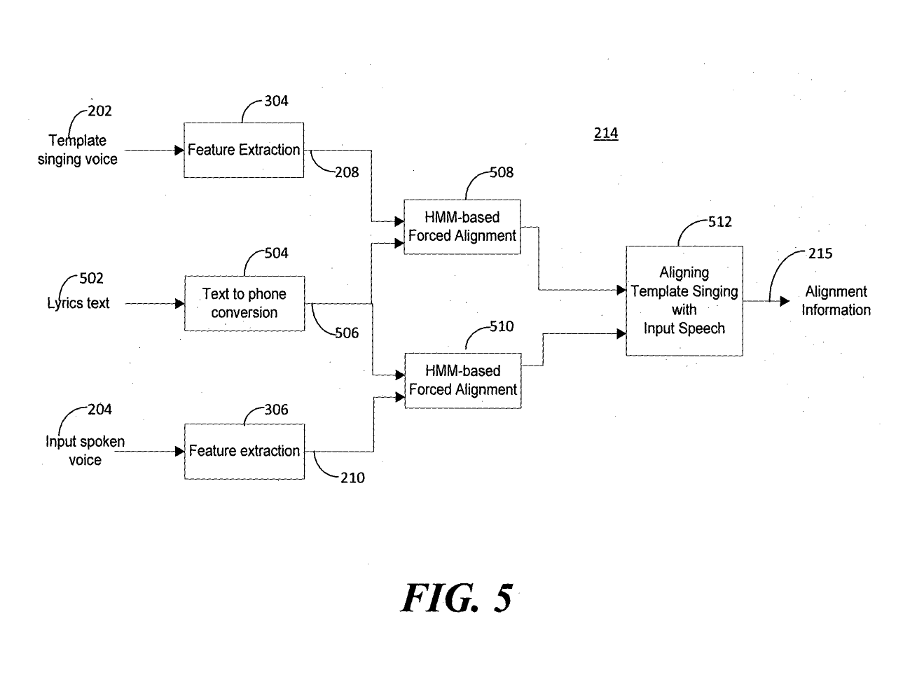

Referring to FIG. 5, a third variant of the alignment method 214 uses a Hidden Markov Model based (HMM-based) speech recognition method for alignment. While DTW works well for clean signals, often there is noise in the input signal, 204. HMM-based forced alignment can provide a more robust alignment method. HMM uses statistical methods to train models with samples of different variations providing more accurate alignment results in noisy environments than DTW. In addition, this third variant uses lyrics text 502 as a medium instead of the singing individual's spoken voice 402 (FIG. 4).

Text-to-phone conversion 504 extracts alignment information 506 from the lyrics text 502. Then a two-step HMM is performed (similar to the two-step DTW 408, 410 of FIG. 4). First, the template singing voice 202 is matched with the lyrics text 502 by HDD-based forced alignment 508 of the alignment information 208 and the alignment information 506. Next, the alignment information 506, 210 of the lyrics text 502 and the input spoken voice 204 are combined by HMM-based forced alignment 510. At alignment 512, the two pieces of alignment information from the HMMs 508, 510 are combined, thereby generating the alignment information 215 between the input spoken voice 204 and the template singing voice 202.

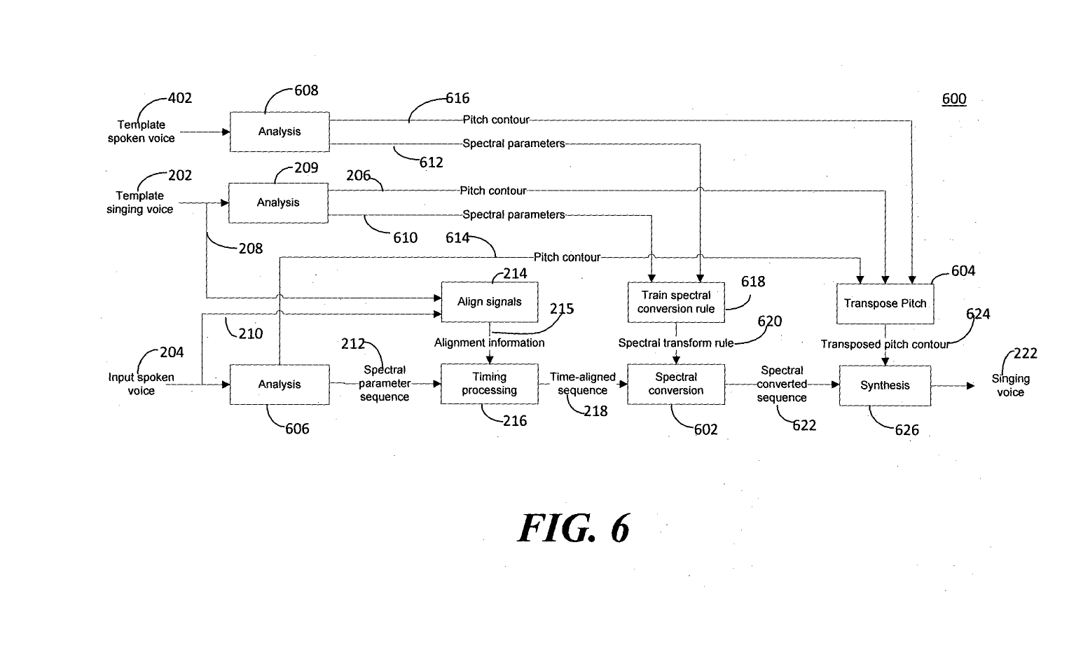

A more complete depiction 600 of the template-based personalized singing synthesis method is shown in FIG. 6. Compared to FIG. 2, the major difference is that a spectral conversion process 602 and a pitch transposition process 604 are added utilizing the additional template spoken voice 402 introduced in FIG. 4.

Alignment 214 of the input spoken voice 204 (user's voice) and the template singing voice 202 set up time mapping between segments of same sound in the two different sequences. Analysis 606 of the input spoken voice 204, the analysis 209 of the template singing voice 202, and analysis 608 of the template spoken voice 402 are extract spectrum information 212, 610, 612 and pitch contour 614, 206, 616 from each signal 204, 202, 402.

The template spoken voice 402 and the template singing voice 202 are from the same person. By comparing the analysis 612, 610 of the two voices 402, 202, we are able to find the spectral difference of the two voices to train a spectral conversion rule 618, thereby forming the rule 620 for spectral transformation.

At the timing processing 216, the alignment information 215 is used to regenerate the spectral sequence 218 so that the voice segments match those of the singing voice. The rule for spectral transformation 620 is used for the spectral conversion 602 which transforms the regenerated the spectral sequence 218 to obtain a spectrally converted sequence 622 of the user's spoken voice. The pitch transposition 604 transposes the pitch contour 616 according to the relationship between the pitch contours 206 614 to generate a transposed pitch contour 624 thereby bringing the melody of the template singing to a level that is more suitable for the user's voice. Finally, a synthesis component 626 uses the transformed spectral parameter sequence 622 and the transposed pitch contour 624 from the template singing voice to generate the personalized singing voice 222.

While implementations of the system and method for personalized speech-to-singing synthesis has been shown in FIG. 1, FIGS. 2 to 5, and FIG. 6, those skilled in the art will realize that there are many other implementations possible and many different ways to implement each component in the system. For example, speech signal analysis and synthesis can be done with STRAIGHT, a high quality vocoder. In the analysis 608, 209, 606, F₀ (pitch) contour, spectral envelope, aperiodicity index (AP) as well as labels for voiced and unvoiced regions (VUV) are calculated from singing or speech signals. In this manner, the synthesis 626 is a reverse process that generate voice signal from F₀ contour, spectral envelope, and AP index.

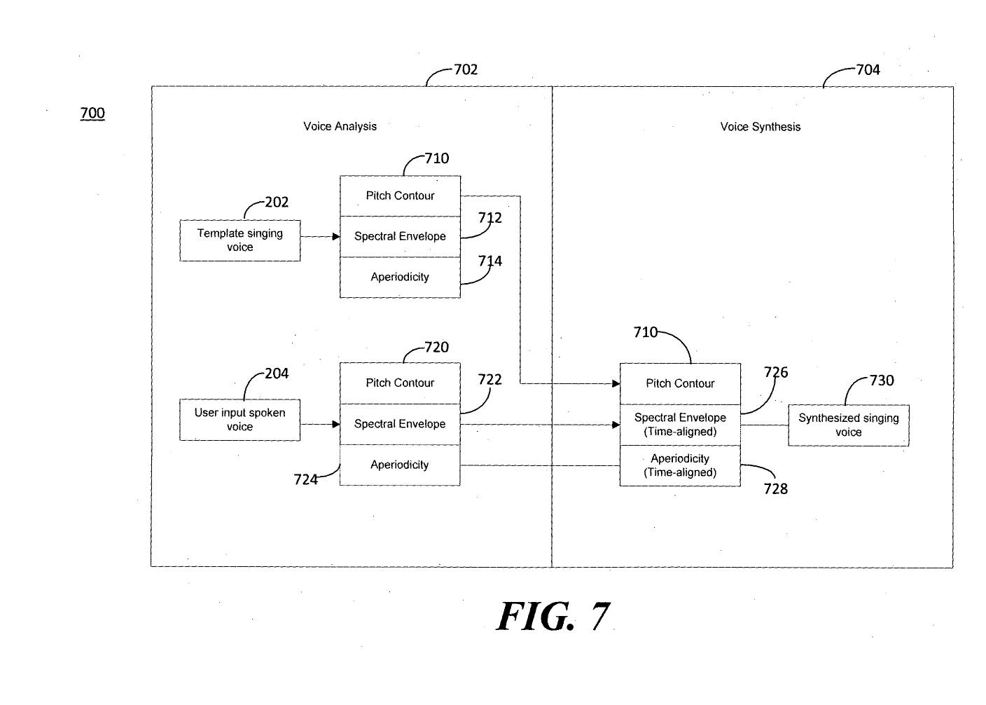

Referring to FIG. 7, a system 700 for voice analysis 702 and voice synthesis 704 in accordance with the present embodiment is depicted. Both the template singing voice 202 and the user input spoken voice 204 are analyzed and each signal is converted into pitch contour 710, 720, spectral envelope 712, 722, and aperiodicity sequences 714, 724. Then the spectral envelope 722 and the aperiodicity sequences 724 are rearranged 726, 728 to align with that 712, 714, of the template singing voice signal 202. The pitch contour 720 of the spoken voice 204 is replaced by the singing 202 pitch contour 710. Finally, the synthesized singing signal 730 is generated, with time-aligned spectral envelope 726 and time-aligned aperiodicity 728 from the spoken voice 204, and the pitch contour 710 of the template singing voice 202.

In accordance with the present embodiment, the point of entry and duration of each phoneme in a singing voice must be different from those in a speaking voice. Thus, the two voices should be aligned before deriving the transformation models. The quality of the synthesized singing voices is largely dependent on the accuracy of the alignment results.

As set out previously, the short-time cepstral features, MFCC 114 (FIG. 1), is extracted as acoustic features for deriving the alignment data. The MFCC 114 computes the cosine transform of the real logarithm of the short-time power spectrum on a Mel-warped frequency scale. In addition, the delta and acceleration (delta-delta) of the raw MFCC features are calculated and, along with the voiced-unvoiced decision (VUV) (since the same lyrics are uttered in both singing and speech with the same number of syllables), are important features used in the alignment 120 (FIG. 1).

For example, a full feature set used in alignment may have a dimension of M, where M=40 is the total number of features calculated for each frame. The number of features includes one VUV feature and thirty-nine MFCC features (twelve MFCC features, twelve delta MFCC features, twelve Delta-Delta MFCC features, one (log) frame energy, one Delta (log) frame energy, and one Delta-Delta (log) frame energy). In order to reduce the acoustic variation across different frames and different parameters, frame- and parameter-level normalizations are carried on the MFCC related features. Normalization is performed by subtracting the mean and dividing by the standard deviation of the features given by

$${x}_{ij} = \frac{( {x}_{ij} - {μ}_{pi} ) / {σ}_{pi} - {μ}_{fj}}{{σ}_{fj}} . \qquad ( 2 )$$

where xᵢⱼ is the i^{th} (i≦39) MFCC coefficient of the j^{th} frame, μₚᵢ and σₚᵢ are the mean and standard deviation of the i^{th} MFCC coefficient, and μ_{fj} and σ_{fj} are the mean and standard deviation of the j^{th} frame.

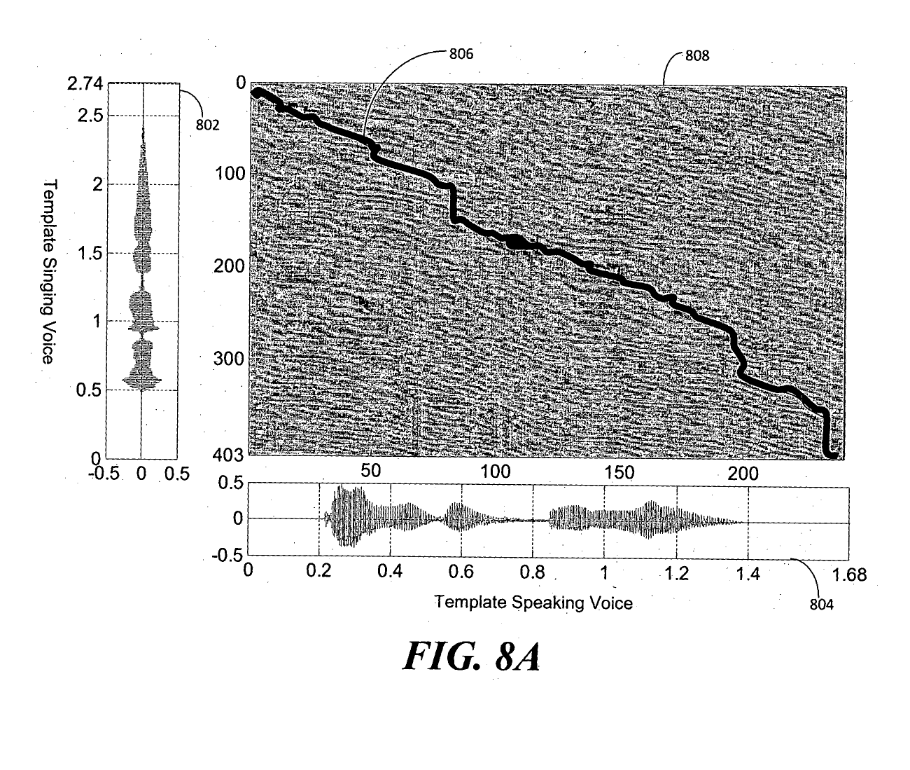

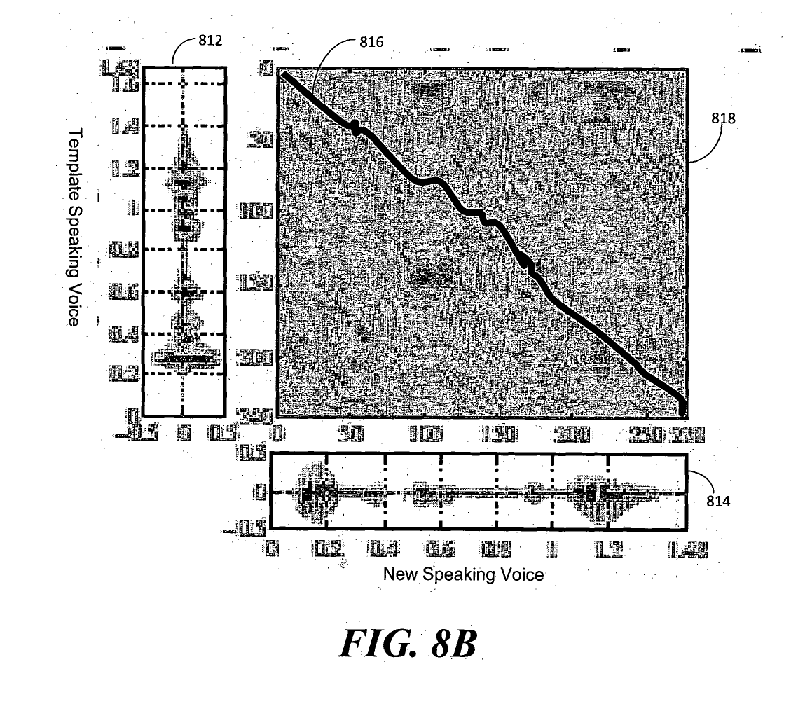

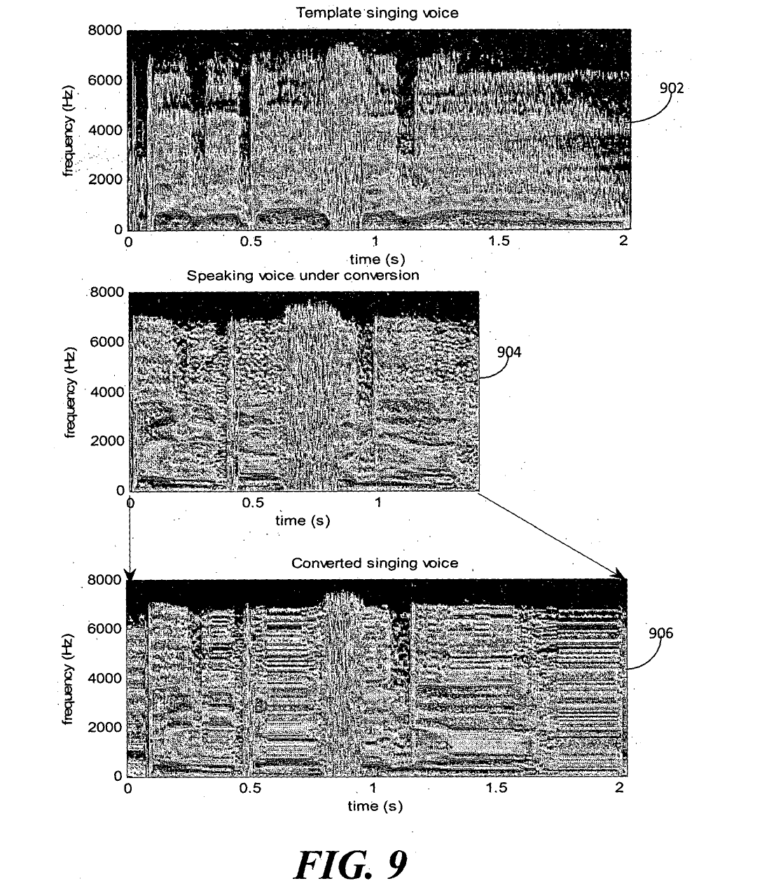

This feature set is used during the alignment 120, 214 that uses the DTW method. The DTW measures the similarity between two sequences which vary in time or speed, aiming to find an optimal match between two sequences. This method has been largely used in ASR to deal with different speaking speeds. Referring to FIG. 8, examples of the alignment results for the lyrics “Dui Ni De Si Nian” in a Chinese song is shown, where FIG. 8A depicts alignment results for DTW 408 (FIG. 4) and FIG. 8B depicts alignment results for DTW 410. In FIG. 8A, the waveform 802 on the left and the waveform 804 on the bottom represent the two voices to be aligned, the template singing voice 202 and the template speaking voice 402. The black line 806 indicates an optimal warping path in the time warping matrix 808 of the middle plot. In FIG. 8B, the waveform 812 on the left and the waveform 814 on the bottom represent the two voices to be aligned, the template peaking voice 402 and the new speaking voice 204. The black line 816 indicates an optimal warping path in the time warping matrix 818 of the middle plot.

Referring to FIG. 9, the modified duration of the phonemes for the utterance “Dui Ni De Si Nian” are depicted in a spectrogram 902 of the template singing voice, a spectrogram 904 of the converted speech, and a spectrogram 906 with modified duration of phonemes. It can be seen from this figure that the phoneme durations in the template singing and the synthesized singing are similar.

Thus, in accordance with the present embodiment a personalized template based singing voice synthesis system is provided that is able to generate a singing voice from the uttered lyrics of a song. The template singing voice is used to provide a very natural melody of the song, while the user's spoken voice is used to keep the user's natural voice timbre. In doing so, the singing voice is generated with a general user's voice and a professional melody.

The proposed singing synthesis has many potential applications in entertainment, education, and other areas. The method of the present embodiment enables the user to produce and listen to his/her singing voice merely by reading the lyrics of songs. As the template singing voices are used in the system, we are able to acquire a natural pitch contour from that of the actual singing voice without a need to purposely generate natural fluctuations (such as overshoot and vibrato) from a step contour directly from the musical score. This substantially improves the naturalness and quality of the synthesized singing and makes it possible to create professional-quality singing voice for poor singers. As the synthesized singing preserves the timbre of the speaker, it can sound like it is being sung by the speaker.

The technology of the present embodiment and its various alternates and variants can also be used for other scenarios. For example, in accordance with the present embodiment, the singing from an unprofessional singer can be modified by correcting the imperfect parts to improve the quality of his/her voice. Alternatively, a student can be taught how to improve his singing by detecting the errors in his/her singing melody.

Thus, it can be seen that a system and method for speech-to-singing synthesis which reduces complexity of the synthesis as well as simplifying operations by the end user has been provided. While exemplary embodiments have been presented in the foregoing detailed description of the invention, it should be appreciated that a vast number of variations exist.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

1. A method for speech-to-singing synthesis comprising:
deriving characteristics of a singing voice for a first individual; and
modifying vocal characteristics of a voice for a second individual in response to the characteristics of the singing voice of the first individual to generate a synthesized singing voice for the second individual,
wherein modifying the vocal characteristics of the voice of the second individual comprises aligning the voice of the second individual to the singing voice of the first individual.

2. The method in accordance with claim 1 wherein the voice of the second individual is speech.

3. The method in accordance with claim 1 wherein the voice of the second individual is imperfect singing, and wherein the synthesized singing voice is corrected singing.

4. The method in accordance with claim 1 wherein modifying the vocal characteristics of the voice of the second individual comprises modifying pitch of the voice of the second individual in response to the characteristics of the singing voice of the first individual to generate the synthesized singing voice for the second individual.

5. The method in accordance with claim 1 wherein modifying the vocal characteristics of the voice of the second individual comprises modifying spectrum of the voice of the second individual in response to the characteristics of the singing voice of the first individual to generate the synthesized singing voice for the second individual.

6. The method in accordance with claim 1 wherein modifying the vocal characteristics of the voice of the second individual comprises modifying the vocal characteristics of the voice of the second individual in response to alignment of a voice of the first individual to the voice of the second individual to generate the synthesized singing voice for the second individual.

7. The method in accordance with claim 6 wherein alignment of the voice of the first individual to the voice of the second individual comprises:
aligning the singing voice of the first individual to a spoken voice of the first individual;
aligning the spoken voice of the first individual to the voice of the second individual; and
combining results of the aligning steps to obtain alignment of the singing voice of the first individual to the voice of the second individual.

8. The method in accordance with claim 6 wherein alignment of the voice of the first individual to the voice of the second individual comprises:
aligning the singing voice of the first individual to text;
aligning the text to the voice of the second individual; and
combining results of the aligning steps to obtain alignment of the singing voice of the first individual to the voice of the second individual.

9. A method for speech-to-singing synthesis comprising:
deriving a template of first speech characteristics and first singing characteristics in response to a first individual's speaking voice and singing voice;
extracting second speech characteristics from a second individual's speaking voice;
modifying the second speech characteristics in accordance with the template to generate the second individual's approximated singing voice; and
aligning acoustic features of the second individual's approximated singing voice to the template of the first speech characteristics, the first singing characteristics and the second speech characteristics to generate the second individual's synthesized singing voice.

10. The method in accordance with claim 9 wherein the alignment step comprises aligning the acoustic features of the second individual's approximated singing voice in response to the first speech characteristics, the first singing characteristics and the second speech characteristics in accordance with a dynamic time warping (DTW) algorithm to generate the second individual's synthesized singing voice.

11. The method in accordance with claim 9 wherein the alignment step comprises:
generating a first dynamic time warping (DTW) of the first speech characteristics and the first singing characteristics;
generating a second DTW of the first speech characteristics and the second speech characteristics; and
aligning acoustic features of the second individual's approximated singing voice in response to results of the first DTW and the second DTW to generate the second individual's synthesized singing voice.

12. The method in accordance with claim 11 wherein the first generating step comprises generating the first DTW of the first speech characteristics and the first singing characteristics to align the first speech characteristics and the first singing characteristics to generate a template alignment in accordance with optimal mapping of the first speech characteristics and the first singing characteristics.

13. The method in accordance with claim 11 wherein the second generating step comprises generating the second DTW of the first speech characteristics and the second speech characteristics to align the first speech characteristics and the second speech characteristics to generate an alignment therebetween in accordance with optimal mapping of the first speech characteristics and the second speech characteristics.

14. The method in accordance with claim 10 wherein the alignment step comprises deriving synchronization information in response to the first speech characteristics, the first singing characteristics and the second speech characteristics and aligning the acoustic features of the second individual's approximated singing voice in response to the synchronization information to generate the second individual's synthesized singing voice by optimal mapping of results of the DTW algorithm.

15. The method in accordance with claim 9 wherein the first singing characteristics comprise first pitch, first timing and first spectrum, and wherein the second speech characteristics comprise second pitch, second timing and second spectrum.

16. The method in accordance with claim 15 wherein the aligning step comprises aligning acoustic features of the second individual's approximated singing voice in response to retaining the second spectrum of the second speech characteristics while replacing the second pitch and the second timing of the second speech characteristics with the first pitch and the first timing of the first singing voice.

17. The method in accordance with claim 9 wherein the first speech characteristics and the first singing characteristics comprise a transformation model for a fundamental frequency F₀.

18. The method in accordance with claim 9 wherein the second speech characteristics comprise characteristics selected from Mel-Frequency Cepstral Coefficients (MFCC), short-time energy information, voice and unvoiced (VUV) information, fundamental frequency contour information and spectrum information.

19. A method for speech-to-singing synthesis comprising:
extracting pitch contour information and alignment information from a singing voice of a first individual;
extracting alignment information and a spectral parameter sequence from a spoken voice of a second individual;
aligning the singing voice of the first individual and the spoken voice of the second individual;
converting the spectral parameter sequence from the spoken voice of the second individual using the aligned singing voice of the first individual and the spoken voice of the second individual to generate a converted spectral parameter sequence; and
synthesizing a singing voice for the second individual in response to the converted spectral parameter sequence and the pitch contour information of the singing voice of the first individual.
